(19) United States
(12) Patent Application Publication
(10) Pub. No.: US 2026/0040386 A1
(43) Pub. Date: Feb. 5, 2026

(54) GROUP RRC REESTABLISHMENT IN MOBILE IAB NODES

(71) Applicant: APPLE INC., Cupertino, CA (US)

(72) Inventors: Peng Cheng, Beijing (CN); Ralf Rossbach, Munich (DE); Yuqin Chen, Beijing (CN); Fangli Xu, Beijing (CN); Haijing Hu, Los Gatos, CA (US)

(21) Appl. No.: 18/997,607

(22) PCT Filed: Aug. 8, 2022
(86) PCT No.: PCT/CN2022/110818

§ 371 Date: Jan. 22, 2025

(51) Int. Cl. H04W 76/19; H04W 76/27

(52) U.S. Cl. CPC H04W 76/19; H04W 76/27

(57) ABSTRACT

Group RRC reestablishment in mobile IAB nodes is disclosed. In an embodiment, the IAB node is configured to: in response to a trigger event associated with a group RRC reestablishment with a target donor CU, transmitting a first group common indication to all of a plurality of UEs that are connected to the IAB node; and in response to success of the group RRC reestablishment, transmitting a success indication to the plurality of UEs.

### TECHNICAL FIELD

This disclosure relates generally to wireless communication systems, including group Radio Resource Control (RRC) reestablishment in a mobile Integrated Access and Backhaul (IAB) node.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### SUMMARY OF THE INVENTION

This disclosure is directed to group RRC reestablishment in a mobile IAB node.

According to some embodiments, a computing apparatus for use with an IAB node is disclosed. The computing apparatus comprises: a processor; and a memory storing instructions that, when executed by the processor, configure the IAB node to: in response to a trigger event associated with a group RRC reestablishment between the IAB node A 310nd a target donor center unit (CU), transmit a first group common indication to all of a plurality of UEs that are connected to the IAB node; in response to success of the RRC reestablishment, transmit a success indication to the plurality of UEs.

According to some embodiments, a method performed by an IAB node is disclosed. The method comprises: in response to a trigger event associated with a group RRC reestablishment with a target donor CU, transmitting a first group common indication to all of a plurality of UEs that are connected to the IAB node; in response to success of the group RRC reestablishment, transmitting a success indication to the plurality of UEs.

According to some embodiments, a computing apparatus for use with a UE is disclosed. The computing apparatus comprises: a processor; and a memory storing instructions that, when executed by the processor, configure the UE to: receive a first group common indication from an IAB node to which the UE is connected, the first group common indication indicating a group RRC reestablishment with a target donor CU; in response to receiving the first group common indication, perform one or more particular actions; and in response to receiving, from the IAB node, a success indication associated with success of the group RRC reestablishment, update a key of the UE based on the success indication; and in response to receiving, from the IAB node, a second group common indication associated with failure of the group RRC reestablishment, release a connection with the IAB node.

According to some embodiments, a method performed by a UE is disclosed. The method comprises: receiving a first group common indication from an IAB node to which the UE is connected, the first group common indication indicating a group RRC reestablishment with a target donor CU; in response to receiving the first group common indication, performing one or more particular actions; and in response to receiving, from the IAB node, a success indication associated with success of the group RRC reestablishment, updating a key of the UE based on the success indication; and in response to receiving, from the IAB node, a second group common indication associated with failure of the group RRC reestablishment, releasing a connection with the IAB node.

According to some embodiments, a computing apparatus for use with a donor centralized unit CU is disclosed. The computing apparatus comprising: a processor; and a memory storing instructions that, when executed by the processor, configure the donor CU to: receive, from an IAB node, an RRC reestablishment request; in response to receiving the RRC reestablishment request, transmit a UE context request to a source donor CU to which the IAB node was previously connected to; receive a UE context response from the source donor CU, wherein the UE context response includes UE context for a plurality of UEs that are connected to the IAB node; and perform a group RRC reestablishment with the plurality of UEs based on the UE context response.

According to some embodiments, a computing apparatus for use with a donor CU is disclosed. The computing apparatus comprises: a processor; and a memory storing instructions that, when executed by the processor, configure the donor CU to: receive a UE context request from a target donor CU to which an IAB node is migrating; and transmit a UE context response to the target donor CU, wherein the UE context response includes UE context for a plurality UEs that are connected to the IAB node.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 illustrates an exemplary network environment, according to embodiments disclosed herein.

FIG. 4 illustrates an exemplary network environment in which a migration of an IAB node occurs, according to embodiments disclosed herein.

FIG. 5 illustrates an exemplary network environment in which a migration of an IAB node occurs, according to embodiments disclosed herein.

FIG. 6 illustrates an exemplary group RRC reestablishment process in an IAB node, according to embodiments disclosed herein.

FIG. 7 illustrates an exemplary group RRC reestablishment flow when the RRC reestablishment succeeds, according to embodiments disclosed herein.

FIG. 8 illustrates an exemplary group common RRC message that may be used as a success indication, according to embodiments disclosed herein.

FIG. 9 illustrates an exemplary group RRC reestablishment flow when the RRC reestablishment fails, according to embodiments disclosed herein.

### DETAILED DESCRIPTION

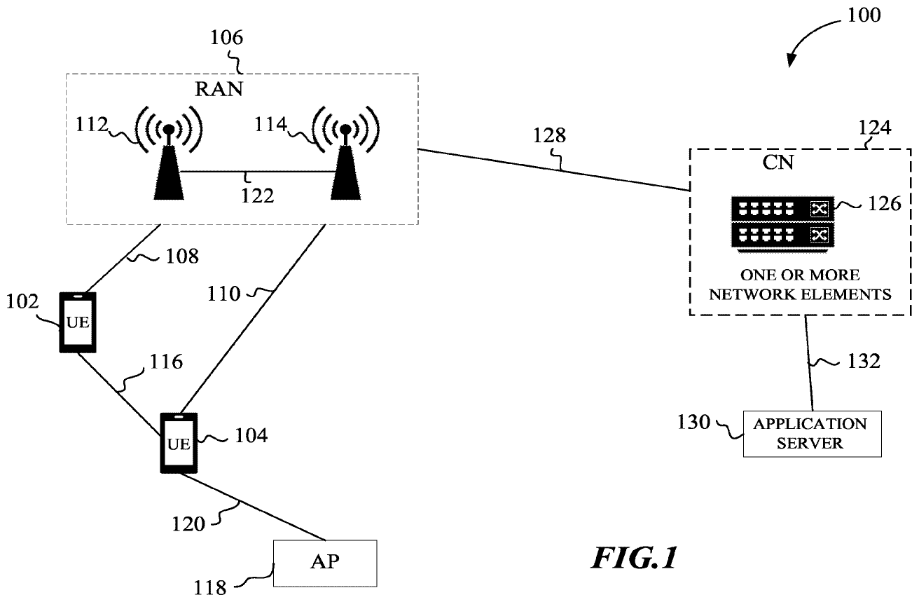

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

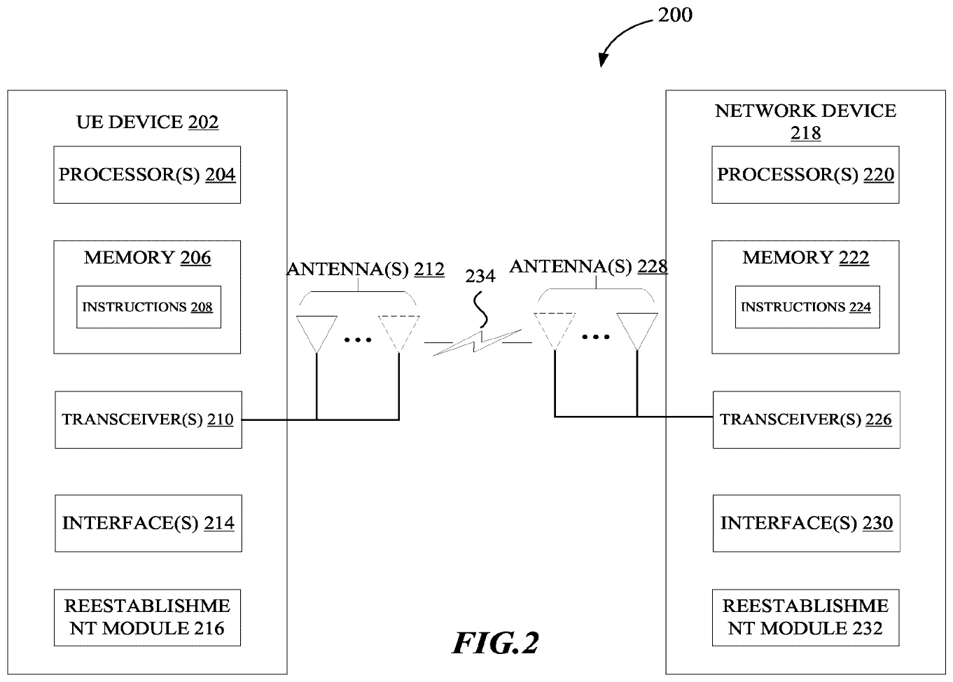

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The wireless device 202 may include a reestablishment module 216. The reestablishment module 216 may be implemented via hardware, software, or combinations thereof. For example, the reestablishment module 216 may be implemented as a processor, circuit, and/or instructions 208 stored in the memory 206 and executed by the processor(s) 204. In some examples, the reestablishment module 216 may be integrated within the processor(s) 204 and/or the transceiver(s) 210. For example, the reestablishment module 216 may be implemented by a combination of software components (e.g., executed by a DSP or a general processor) and hardware components (e.g., logic gates and circuitry) within the processor(s) 204 or the transceiver(s) 210.

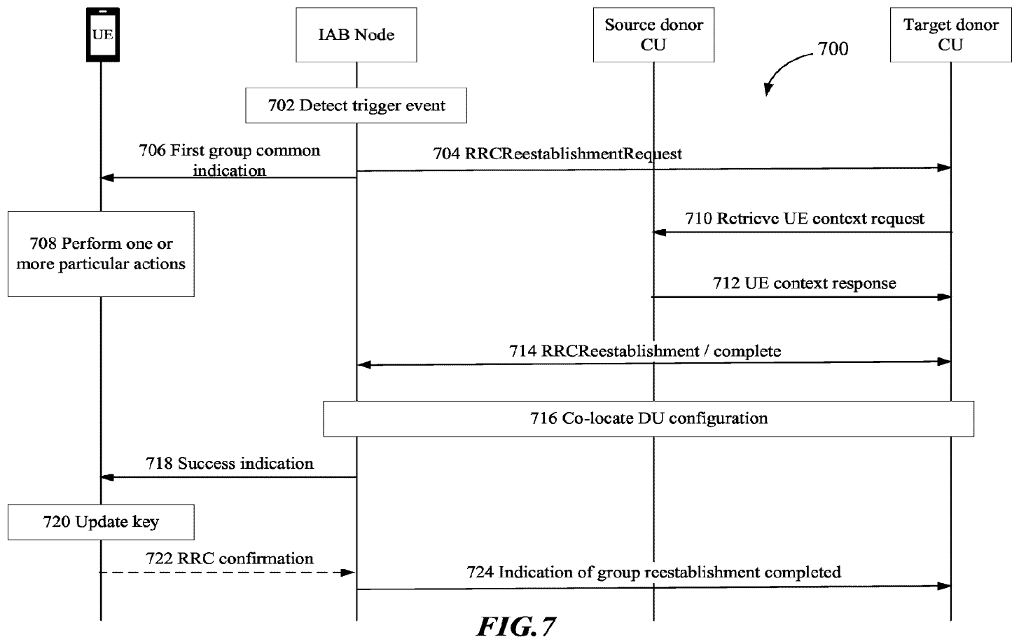

The reestablishment module 216 may be used for various aspects of the present disclosure, for example, aspects of FIGS. 7-9. The reestablishment module 216 is configured to perform the group RRC reestablishment process at the UE side.

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

The network device 218 may include a reestablishment module 232. The reestablishment module 232 may be implemented via hardware, software, or combinations thereof. For example, the reestablishment module 232 may be implemented as a processor, circuit, and/or instructions 224 stored in the memory 222 and executed by the processor(s) 220. In some examples, the reestablishment module 232 may be integrated within the processor(s) 220 and/or the transceiver(s) 226. For example, the reestablishment module 232 may be implemented by a combination of software components (e.g., executed by a DSP or a general processor) and hardware components (e.g., logic gates and circuitry) within the processor(s) 220 or the transceiver(s) 226.

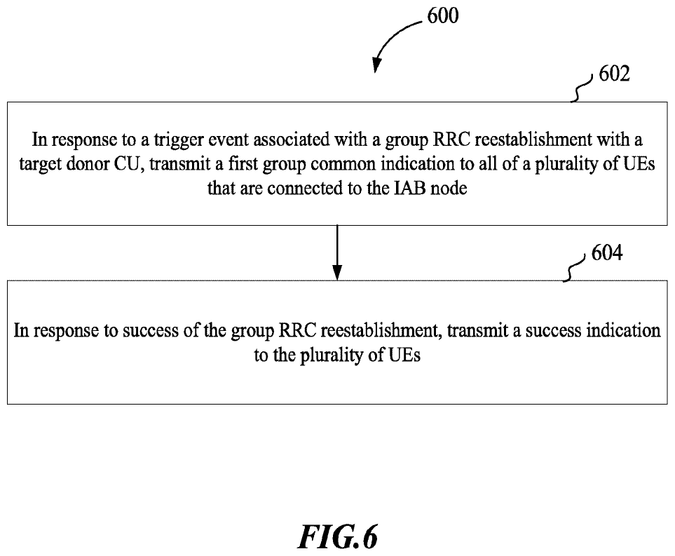

The reestablishment module 232 may be used for various aspects of the present disclosure, for example, aspects of FIGS. 6-9. The reestablishment module 232 is configured to perform the group RRC reestablishment process at the network side.

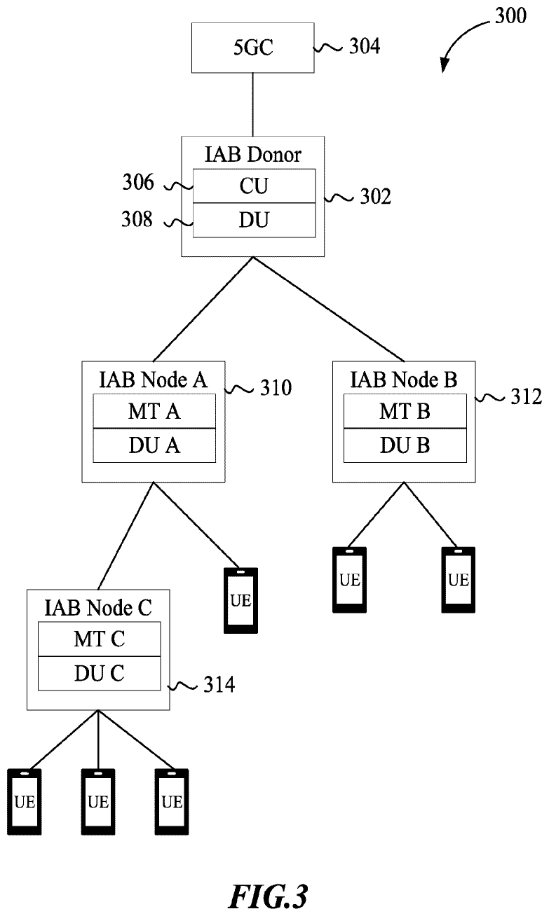

FIG. 3 illustrates an exemplary network environment 300, according to embodiments disclosed herein. The network environment 300 may include an IAB architecture that includes a number of RAN nodes. The RAN nodes together are configured to provide network access to various UEs.

In some embodiments, the RAN nodes of the network environment 300 may include an IAB donor 302. The IAB donor 302 may be coupled with a 3GPP Fifth Generation Core Network (5GC) 304. For example, the IAB donor 302 may be coupled with the 5GC 304 via a fiber backhaul.

In some embodiments, the IAB donor 302 may include a centralized unit (CU) 306 and one or more distributed units (DUs) 308. The CU 306 may be configured to handle higher-layer protocols for the IAB donor 302, for example, radio resource control (RRC), packet data convergence (PDCP), and service data adaptation protocol (SDAP) layer protocols. The DUs 308 may be configured to handle lower-layer protocols for IAB donor 302, for example, radio link control (RLC), media access control (MAC), and physical (PHY) layer protocols.

In some embodiments, the IAB donor 302 may provide a wireless backhaul to one or more IAB nodes in the network environment 300, such as an IAB node A 310, an IAB node B 312, and an IAB node C 314. Some of the IAB nodes (for example, the IAB node A 310 and the IAB node B 312) may be coupled directly with the IAB donor 302 (more specifically, with the DU 308 of the IAB donor 302). Some of the IAB nodes (for example, the IAB node C 314) may be coupled indirectly with the IAB donor 302 over one or more hops through other IAB nodes (for example, the IAB node A 310). The IAB node A 310 may be referred as a parent IAB node for the IAB node C 314, which may provide a wireless backhaul for the IAB node C 314.

In some embodiments, each of the IAB nodes may include a mobile termination (MT) and a DU. A MT of an IAB node may be used to connect the IAB node with an upstream (for example, towards the 5GC 304) RAN node, such as the parent IAB node of the IAB node or the IAB donor 302. The MT may provide the IAB node with access functionality similar to a UE, such that the IAB node may appear like a UE to the upstream RAN node. A DU of the IAB node may be used to connect the IAB node with one or more downstream entities, such as one or more descendent IAB nodes or one or more UEs. The DU may establish an RLC channel to the UEs or to the MTs of the downstream IAB nodes. In the embodiment shown in FIG. 3, the DU A of the IAB node A 310 may connect to the downstream IAB node C 314 and one or more UEs, the DU B of the IAB node B 312 may connect to one or more UEs, and the DU C of the IAB node C 314 may connect to one or more UEs. Each of the UEs may be served by a respective series of IAB nodes (to which it is connected), the IAB donor 302 and eventually the 5GC 304. For example, a UE that is connected to the IAB node C 314 may be served by the IAB node C 314, the IAB node A 310, the IAB donor 302 and eventually the 5GC 304. Another UE that is connected to the IAB node B 312 may be served by the IAB node B 312, the IAB donor 302 and eventually the 5GC 304.

Although FIG. 3 shows a specific example of the network environment 300, it is readily understood that the arrangement of IAB nodes is not limited to this example. The number and the hierarchy of the IAB nodes may vary from one implementation to another. For example, although network environment 300 is shown with three IAB nodes A, B and C, the network environment 300 in other embodiments may include fewer or more IAB nodes. In further embodiments, the IAB nodes may be arranged into more than two levels. Also, although FIG. 3 illustrates that network environment 300 includes a single IAB donor 302 with a single CU 306, network environment 300 in other embodiments may include more IAB donors, such that one or more IAB nodes may migrate from one donor to another donor, which will be discussed in more details below.

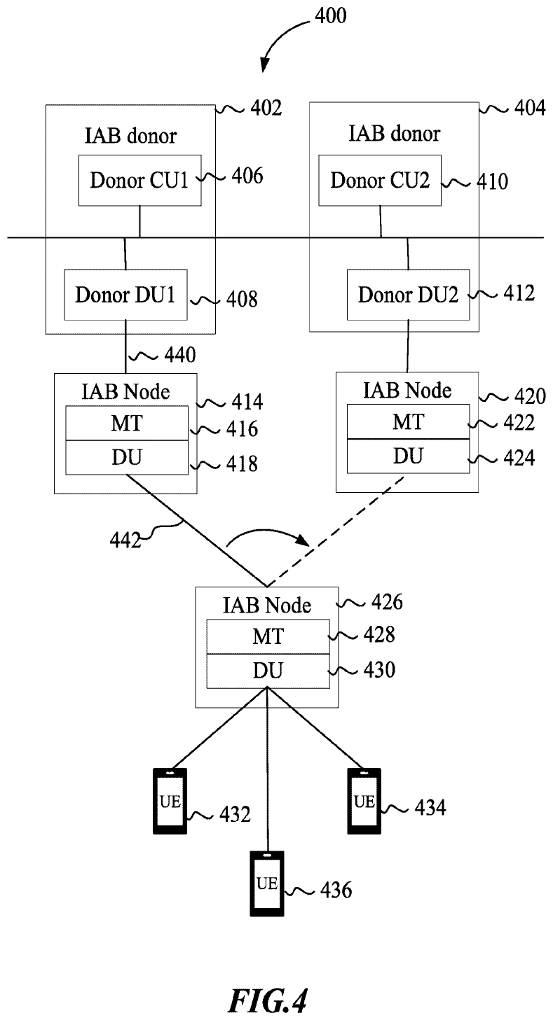

FIG. 4 illustrates an exemplary network environment 400 in which a migration of an IAB node occurs, according to embodiments disclosed herein.

In some embodiments, the network environment 400 may include two IAB donors 402 and 404. Each of the IAB donors 402 and 404 may be mounted at a respective fixed position in a cell they are serving. In some embodiments, the IAB donors 402 and 404 may be connected with each other via one or more connections. In some embodiments, the one or more connections may include one or more wired connections, such that the IAB donors 402 and 404 may reliably communicate with each other.

In some embodiments, each of the IAB donors 402 and 404 may be connected to one or more respective downstream IAB nodes. For example, the IAB donor 402 may be connected to the IAB node 414, and the IAB donor 404 may be connected to the IAB node 420. More specifically, the donor DU 408 of the IAB donor 402 may be connected to the MT 416 of IAB node 414, and the donor DU 412 of the IAB donor 404 may be connected to the MT 422 of the IAB node 420. Although FIG. 4 shows each of the IAB donors 402 and 404 is connected to one descendent IAB node, it is readily understood that the IAB donors 402 and 404 in other embodiments may be connected to more descendent IAB nodes.

In some embodiments, the network environment 400 may further include one or more IAB nodes, such as IAB node 426. In some embodiments, the IAB node 426 may be a mobile IAB node that is able to move in the network environment 400. For example, the IAB node 426 may not be mounted at a fixed position. Instead, the IAB node 426 may be configured to be a movable device in the cell. Mobility of the mobile IAB node 426 may provide flexibility enhancement for the network environment 400.

In some embodiments, mobility of the IAB node 426 may allow the IAB node 426 to migrate from a source IAB donor to a target IAB donor, which is referred as inter-donor migration herein. For example, the IAB node 426 may be initially connected with the IAB donor 402 via the intermediate IAB node 414. At some point, the IAB node 426 may migrate from the IAB donor 402 to the IAB donor 404. Migration of the mobile IAB node 426 may be triggered by various factors, including but not limited to a radio link failure (RLF) associated with the IAB node 426 or one of its parent IAB nodes or a handover (HO) process associated with the IAB node 426.

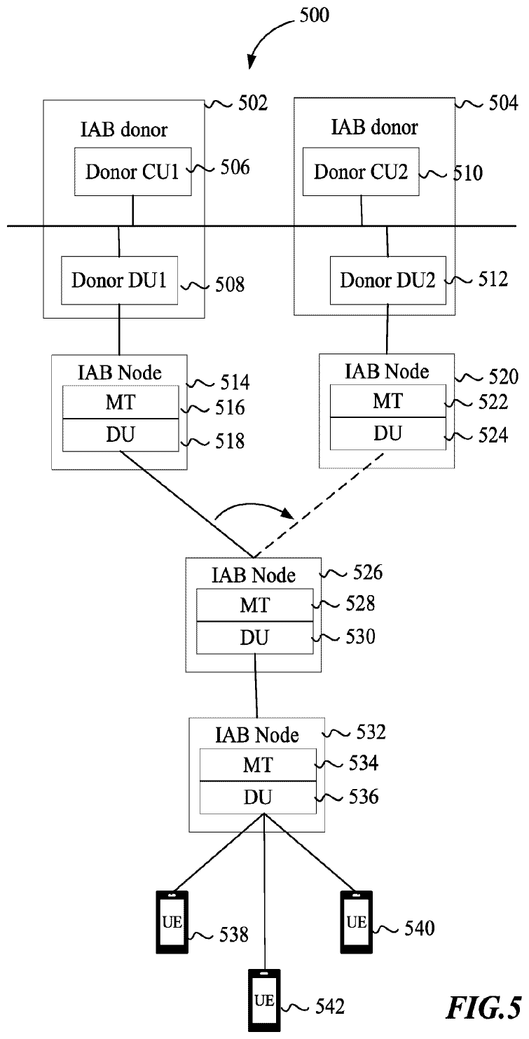

In some embodiments, the inter-donor migration may include inter-donor partial migration. Under inter-donor partial migration, the MT of the migrating IAB node may migrate from a parent IAB node underneath a CU of a source IAB donor to a parent IAB node underneath a CU of a target IAB donor, while the collocated DU(s) of the migrating IAB node and its descendant IAB node(s) retain F1 connectivity with the CU of the source IAB donor. For example, if the IAB node 426 performs an inter-donor partial migration between the source IAB donor 402 and the target IAB donor 404, the MT 428 of the migrating IAB node 426 will migrate from the source parent IAB node 414 to the target parent IAB node 420, while the DU 430 of the migrating IAB node 426 remains F1 connectivity with the CU 406 of the source IAB donor 402. If the migrating IAB node 426 (like the migrating IAB node 526 in FIG. 5) has one or more descendant IAB nodes, the DUs of those descendant IAB nodes will also remain F1 connectivity with the CU 406 of the source IAB donor 402. After the inter-donor partial migration, F1 traffic of the DU 430 of the migrating IAB node 426 and its descendant IAB node(s) will be routed via a BAP layer of the topology to which the MT 428 of the migrating IAB node 426 has migrated.

In other embodiments, the inter-donor migration may include inter-donor full migration. The inter-donor full migration may cause both of the MT and the DU of a migrating IAB node and its descendant IAB nodes to migrate from a parent IAB node underneath a CU of a source IAB donor to a parent IAB node underneath a CU of a target IAB donor. The collocated DU(s) of the migrating IAB node and its descendant IAB node(s) will not retain F1 connectivity with the CU of the source IAB donor, which is different from the inter-donor partial migration.

FIG. 5 illustrates another exemplary network environment 500 in which a migration of an IAB node occurs, according to embodiments disclosed herein. In general, the network environment 500 is similar to the network environment 400 of FIG. 4, except for that the migrating IAB node 526 in the network environment 500 in an intermediate IAB node instead of a boundary IAB node like the IAB node 426. Specifically, the IAB node 526 has at least one descendant IAB node (such as the IAB node 532), such that the IAB node 526 may act as an intermediate IAB node in the network environment 500. In contrast, the IAB node 426 in the example of the environment 400 is a boundary IAB node that has no descendant IAB nodes but only serves one or more UEs. As a result, migration of the IAB node 526 will affect its descendant IAB nodes (such as the IAB node 532) and each UE that is connected to IAB node 526 and the descendant IAB nodes (such as UEs 538, 540, and 542).

With migration of a mobile IAB node as discussed above, all the UEs and descendant IAB nodes (if any) that are connected to the migrating IAB node may migrate along with the IAB node. Mobility of an IAB node together with its served UE and descendant IAB nodes (if any) may be referred as group mobility herein. Enhancements related to such group mobility are desired, in order for, for example, mitigation of interference (including avoidance of potential reference and control signal collisions), reduction of signaling overhead, and/or optimization of performance. The group RRC reestablishment as described herein may be one of such enhancements.

FIG. 6 illustrates an exemplary group RRC reestablishment process 600 in an IAB node, according to embodiments disclosed herein.

In some embodiments, the process 600 may be performed by an IAB node (such as the IAB node 426 or 526). The IAB node may be a mobile IAB node. The mobile IAB node may be migrating from a source donor CU to a target donor CU, as described above. Alternatively, the process 600 may be performed by a computing apparatus for use with this IAB node. The IAB node or the computing apparatus may be implemented as the network device 218 as described with respect to FIG. 2. In this case, the process 600 may be performed by the reestablishment module 232 of the network device 218.

In some embodiments, the process 600 may begin with step 602. In this step, the IAB node may be configured to transmit a first group common indication to all of a plurality of UEs that are connected to the IAB node. The first group common indication may be transmitted in response to a trigger event that is associated with a group RRC reestablishment with a target donor CU of the IAB node.

In some embodiments, the group RRC reestablishment with the target donor CU may be triggered by a variety of events. In an embodiment, the group RRC reestablishment may be triggered by a radio link failure (RLF) associated with the IAB node or one of its parent IAB nodes. In another embodiment, the group RRC reestablishment may be triggered by a handover (HO) failure associated with the IAB node. In further embodiments, the group RRC reestablishment may be triggered by any other event or condition, which is not limited to examples provided herein.

In some embodiments, the first group common indication transmitted by the IAB node may be a signaling or message that is common to all the UEs connected to the IAB node. In other words, the first group common indication is not dedicated to each individual UE (not UE-dedicated) but is shared by all the connected UEs.

In some embodiments, the first group common indication transmitted by the IAB node may indicate, to all the connected UEs, that a RRC reestablishment process is to be initialized. In an embodiment, the first group common indication may be a one-bit flag, with a preconfigured value to indicate that the RRC reestablishment process is to be initialized. In optional embodiments, the first group common indication may further contain any other suitable information as well.

In some embodiments, the first group common indication may be transmitted via a Layer 2 (L2) signaling. For example, the first group common indication may comprise a MAC CE signaling that is group common to all the connected UEs. In alternative embodiments, the first group common indication may be transmitted via a Layer 1 (L1) signaling. For example, the first group common indication may comprise a downlink control information (DCI) signaling that is group common to all the connected UEs.

In some embodiments, the target donor CU with which the group RRC reestablishment will be performed may be determined according to various factors, including communication quality associated with all candidate IAB donors. In some embodiments, the determined target donor CU may be a new donor CU that is different from a source donor CU to which the IAB node was initially connected. In some embodiments, the determined target donor CU may be a same donor CU as the source donor CU to which the IAB node was initially connected. Depending on whether the determined target donor CU is the same one as the source donor CU, the group RRC reestablishment may vary in some steps, as discussed below.

The process 600 may proceed to step 604. In this step, in response to success of the group RRC reestablishment, the IAB node may be configured to transmit a success indication to the connected UEs.

In some embodiments, the success indication transmitted by the IAB node may be UE-dedicated. In this example, the IAB node may be configured to prepare and transmit a UE-dedicated message to each individual UE that is connected to the IAB node. In alternative embodiments, the success indication transmitted by the IAB node may be a group common message. In this example, the IAB node may be configured to transmit a group common RRC message to all the UEs that are connected to the IAB node.

In optional embodiments, the process 600 may further include receiving, by the IAB node and from the connected UEs, an RRC confirmation that is responsive to the success indication. The RRC confirmation may indicate that a respective UE has successfully updated its key based on the success indication.

In optional embodiments, the process 600 may further include transmitting, by the IAB node and to the target donor CU, an indication that the group RRC reestablishment is complete.

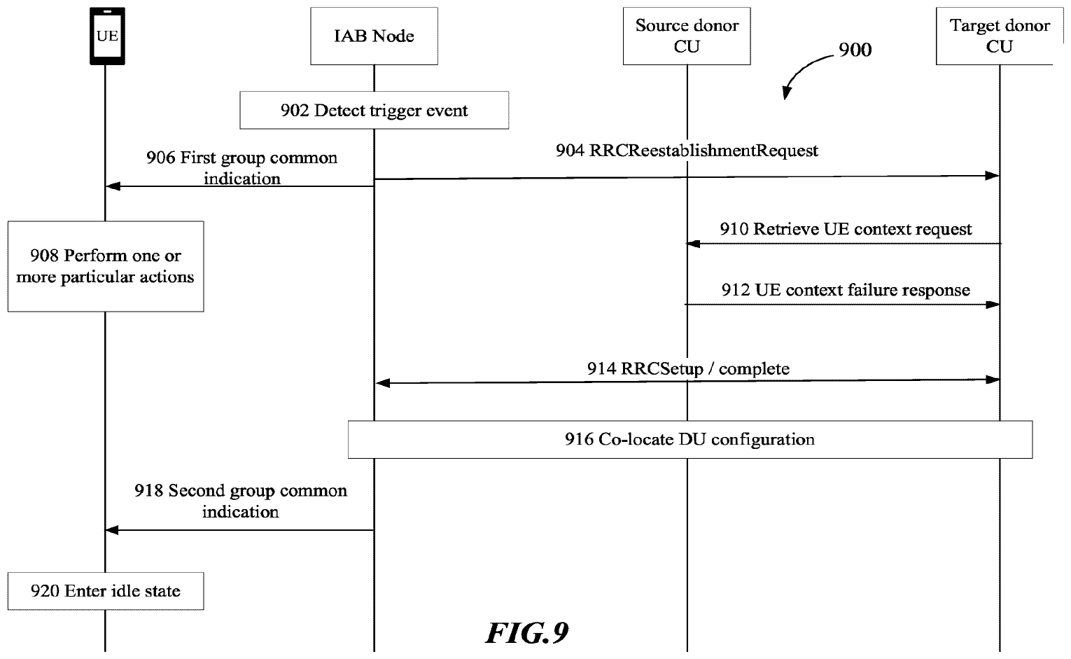

Although FIG. 6 shows the process 600 with certain steps, it is readily understood that the process 600 in other embodiments may include fewer or more steps than those described above. The group RRC reestablishment process will be discussed with respect to FIG. 7 and FIG. 9 below with more details.

FIG. 7 illustrates an exemplary group RRC reestablishment flow 700 when the RRC reestablishment succeeds, according to embodiments disclosed herein.

The flow 700 is shown with a mobile IAB node, UEs that are connected to the mobile IAB node, a source donor CU of the mobile IAB node, and a target donor CU of the mobile IAB node. In some embodiments, the mobile IAB node may be an IAB node that is migrating. The flow 700 may further involve other entities, which are not shown in the figure so as to avoid unnecessarily obscuring the subject.

For clarity purpose, the flow 700 will be mainly discussed with respect to the example of FIG. 4. As such, the mobile IAB node may be, for example, the IAB node 426. The UEs that are connected to the mobile IAB node may be, for example, UEs 432, 434, and 436 connected to the IAB node 426. The source donor CU of the IAB node may be, for example, the donor CU 406, to which the IAB node 426 was initially connected to. The target donor CU may be, for example, the donor CU 410, to which the IAB node 426 is migrating.

In some embodiments, the flow 700 may begin at step 702, where the IAB node detects a trigger event associated with a group RRC reestablishment process.

As discussed above, the trigger event may include but not limited to an RLF failure or a HO failure associated with the IAB node or one of its parent IAB nodes. In an embodiment, if an RLF on any of the radio links (for example, 440, 442) between the source donor CU 406 and the IAB node 426 is detected, the group RRC reestablishment may be triggered by the IAB node 426. In another embodiment, if the IAB node 426 attempts to handover from one parent node to another and the handover fails, the group RRC reestablishment may be triggered by the IAB node 426. Specifically, the trigger event is detected if the IAB node 426 receives an RLF/RLF indication in BAP header or a HO failure. It is readily understood that the RLF failure and HO failure are examples of the trigger event, the trigger event in other embodiments may further include any other event or condition that conventionally or will be designed to invoke the RRC reestablishment with the network.

In response to detection of the trigger event, the IAB node may be configured to send, at step 704, an RRC reestablishment request (e.g., an RRCReestablishmentRequest message) to the target donor CU, so as to initialize the group reestablishment process with the target donor CU.

In response to detection of the trigger event, the IAB node may be configured to further transmit, at step 706, a first group common indication to all the UEs that are connected to the IAB node. For example, the IAB node 426 may be configured to transmit a first group common indication to UEs 432, 434 and 436 if a group RRC reestablishment with target donor CU 410 is triggered. UEs 432, 434 and 436 herein may represent a collective set of UEs that are connected to (and thus served by) the IAB node 426. Although step 706 is shown after step 704 in the flow 700, step 706 in other embodiments may be performed before, or simultaneously to step 704.

In some embodiments, the first group common indication may be carried in a L2 (e.g., MAC CE) signaling, as discussed above. For example, the DU 430 of the IAB node 426 may be configured to send a group common MAC CE signaling to all the connected UEs 432, 434, and 436. The group common MAC CE signaling may be sent via Group Radio Network Temporary Identity (G-RNTI) scheduling. In some embodiments, the G-RNTI for transmission of the group common MAC CE signaling may be preconfigured to the UEs 432, 434, and 436 via a UE-dedicated signaling. In alternative embodiments, the G-RNTI for transmission of the group common MAC CE signaling may be derived based on Cell Radio Network Temporary Identity (C-RNTI) associated with the UEs 432, 434, and 436. It is readily understood that other L2 signaling may be used to carry the first group common indication, which is not limited to the MAC CE signaling.

In some embodiments, the first group common indication may be carried in a L1 (e.g., DCI) signaling, as discussed above. For example, the DU 430 of the IAB node 426 may be configured to send a group common DCI signaling to all the connected UEs 432, 434, and 436. It is readily understood that other L1 signaling may be used to carry the first group common indication, which is not limited to the DCI signaling.

In some embodiments, the first group common indication may indicate, to all the connected UEs 432, 434, and 436, that a group RRC reestablishment process is to be initialized, thereby indicating these UEs to perform one or more particular actions. Upon receiving the first group common indication from the IAB node 426 each of the UEs 432, 434, and 436 may be configured to perform the one or more particular actions at step 708.

In an embodiment, the one or more particular actions performed by each of the UEs 432, 434, and 436 may include suspension of data transmission and/or reception of the UE, which stops data communication between the UE and the IAB node 426 at least during the group RRC reestablishment process.

In a further embodiment, the one or more particular actions performed by each of the UEs 432, 434, and 436 may include stopping a data inactivity timer that is maintained at the UE. Usually, each UE maintains a data inactivity timer (for example, a DataInactivityTimer) to count a time during in which no data activity of the UE occurs. The data inactivity timer is designed to, if expired, send the UE to an idle state. By stopping this data inactivity timer upon receiving the first group common indication, the UE may stay in the active state to wait for completion of the group RRC reestablishment process. Otherwise, the UEs 432, 434, and 436 may enter the idle state before the group RRC reestablishment process is completed, because the data inactivity timer expires.

In a further embodiment, the one or more particular actions performed by each of the UEs 432, 434, and 436 may further include sending an indication to the RRC layer for preparation of reception of RRCReestablishment message.

In some embodiments, in response to receiving the RRC reestablishment request from the IAB node 426, the target donor CU may or may not be configured to retrieve UE context for UEs connected to the IAB node 426, which depends on whether the target donor CU is the same one as the source donor CU.

In some embodiments, the target donor CU may be a new donor CU that is different from a source donor CU to which the IAB node was initially connected. For example, the IAB node 426 may be initially connected to the source donor CU 406, while the target donor CU may be determined as the donor CU 410. In this case, the group RRC reestablishment may require the target donor CU 410 to retrieve UE context from the source donor CU 406, because the source donor CU 406 previously stored the UE context for the UEs 432, 434, and 436 associated with the IAB node 426.

In other embodiments, the target donor CU may be a same donor CU as the IAB node was initially connected to. For example, the IAB node 426 may be initially connected to a source donor CU 406 while the target donor CU may still be determined as the donor CU 406. In this case, the group RRC reestablishment do not require retrieving of UE context for UEs associated with the IAB node 426, because the target donor CU 406 has already stored the UE context. As discussed above, the target donor CU may be determined by various factors, including communication quality associated with all candidate IAB donors. For example, if an RLF occurs to the IAB node 426, the IAB node 426 may perform a selection between candidate IAB donors, which may lead to a IAB donor with the highest communication quality with the IAB node 426.

If the determined target donor CU (such as 406) is same as the source donor CU (such as 406), the steps 710 and 712 of the flow 700 may be omitted, because the target donor CU 406 has already stored the UE context for UEs 432, 434, and 436 and the MT 428 that are connected to the IAB node 426.

If the determined target donor CU (such as the donor CU 410) is different from the source donor CU (such as the donor CU 406), the target donor CU may be configured to retrieve UE context from the source donor CU at step 710. For example, the target donor CU 410 may be configured to send a retrieve UE context request (e.g., a RetrieveUEContextRequest message) to the source donor CU 406. In an embodiment, this retrieve UE context request may be delivered via one XnAP message. In other embodiments, this retrieve UE context request may be delivered via any other suitable message between the target donor CU 410 and the source donor CU 406.

Upon receiving the retrieve UE context request, the source donor CU 406 may be configured to prepare and send, at step 712, a UE context response (e,g., a RetrieveUEContextResponse message) to that request. The source donor CU 406, which previously served the IAB node 426, typically stored and maintained UE context associated with all the UEs 432, 434, and 436 that are connected to the IAB node 426. In response to the retrieve UE context request, the source donor CU 406 may be configured to format the UE contexts into a UE context response and send to response to the target donor CU 410.

In some embodiments, the UE context response of the source donor CU may include one or more of the following:
Identifier(s) of DU(s) of the IAB node and its descendent IAB nodes (if any);
UE context of the MT of the IAB node that initializes the group RRC reestablishment process; and/or
UE context of all the UEs that are connect to the IAB node.

For the example of the mobile IAB node 426, the UE context response may include one or more of: (1) an identifier of the DU 430 of the IAB node 426, (2) UE context of the MT 428 the IAB node 426, and/or (3) UE context of each of UEs 432, 434, and 436.

If the target donor CU 410 has successfully obtained valid UE context for the UEs 432, 434, and 436 that are connected to the IAB node 426, the target donor CU 410 and the IAB node 426 may communicate an indication on the RRC reestablishment process (for example, a RRCReestablishment/complete message) at step 714. The RRC reestablishment with the target donor CU 410 may be based on at least the UE context information that is retrieved by the target donor CU 410 from the source donor CU 406 associated with the IAB node 426. If the target donor CU 410 fails to obtain UE context for the UEs 432, 434, and 436 that are connected to the IAB node 426, the target donor CU 410 may not be able to perform the RRC reestablishment but will instead perform an RRC setup process (which is discussed in FIG. 9).

After step 714, DU configuration associated with the IAB node 426 may be co-located. The co-location may involve the IAB node 426, the source parent node 414 (not shown) of the IAB node 426, the target parent node 420 (not shown) of the IAB node 426, the source donor CU 406, and the target donor CU 410. Specifically, given that the IAB node 426 has migrated from the source donor CU 406 to the target donor CU 410, DUs associated with the IAB node 426 need to be changed from an old configuration associated with the source donor CU 406 to a new configuration associated with the target donor CU 410. In some embodiments, DUs associated with the IAB node 426 may include each DU that is included in a RAN node proceeding the IAB node 426.

In some embodiments, in response to success of the group RRC reestablishment (such as receiving the indication in step 714), the IAB node 426 may be configured to transmit, at step 718, a success indication to the plurality of UEs 432, 434, and 436.

In some embodiments, the success indication transmitted by the IAB node 426 may be UE-dedicated. For example, the IAB node 426 may be configured to transmit a UE-dedicated RRC message to each of UEs 432, 434, and 436. Each UE-dedicated RRC message is aimed for a respective UE and may include a respective NextHop Chaining Counter (NCC) for that UE to update its respective key.

The UE-dedicated RRC message may be implemented in any suitable manner. In some embodiments, the IAB node 426 may be configured to reuse a legacy RRC message to implement the UE-dedicated RRC message, such as an RRCReestablishment message or an RRCReestablishmentComplete message. In alternative embodiments, the IAB node 426 may be configured to introduce a new Signal Radio Bearer 1 (SRB1) message as the UE-dedicated RRC message. The SRB1 message may include the NCC with only integrity protection but no ciphering. In some examples, the SRB1 a message may be considered as KeyUpdate/KeyUpdateComplete RRC message.

In alternative embodiments, the success indication transmitted by the IAB node 426 may be a group common message. For example, the IAB node 426 may be configured to transmit a group common RRC message to all the UEs 432, 434, and 436.

In an embodiment, the group common RRC message may be sent via a group common MAC CE signaling. For example, the DU 430 of the IAB node 426 may be configured to send the success indication via a group common MAC CE signaling to all the connected UEs 432, 434, and 436. The group common MAC CE signaling may be sent via G-RNTI scheduling. In addition, the G-RNTI for transmission of the group common MAC CE signaling may be preconfigured to the UEs 432, 434, and 436 via a UE-dedicated signaling. Alternatively, the G-RNTI for transmission of the group common MAC CE signaling may be derived based on C-RNTI associated with the UEs 432, 434, and 436. In other embodiments, another group common RRC message may be used instead of the group common MAC CE signaling.

In an embodiment, the group common RRC message may include a list of NCCs that contains a plurality of NCCs. Each of the plurality of NCCs may be used for a respective UE of the connected UEs 432, 434, and 436. In other words, the group common RRC message may include a respective NCC for a respective UE of the connected UEs 432, 434, and 436. The respective NCC may be used by the respective UE to update a key associated with that UE.

In an optional embodiment, for each of the connected UEs 432, 434, and 436, the group common RRC message may further include a Message Authentication Code-Integrity (MAC-I) that is specific to said each UE. Once the group common RRC message is received by a respective UE, the respective MAC-I may be extracted and checked by that UE against a respective key of the UE, for integrity protection purpose.

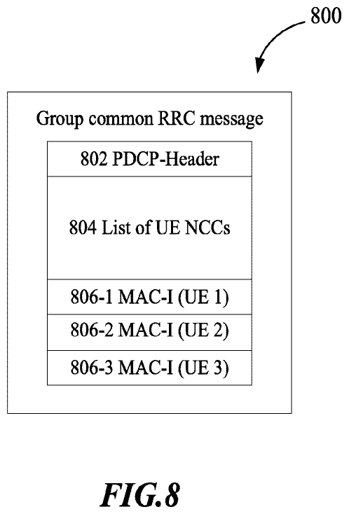

FIG. 8 illustrates an exemplary group common RRC message 800 that may be used as the success indication, according to embodiments disclosed herein.

In this embodiment, the group common RRC message 800 may include a PDCP header 802, a list of UE NCCs 804, and one or more MAC-I information 806. The list of UE NCCs 804 may include a respective NCC for a respective UE of the connected UEs 432, 434, and 436. In addition, the one or more MAC-I information 806 may include a corresponding MAC-I that is specific to each of the connected UEs. For example, the one or more MAC-I information 806 may include a MAC-I 806-1 for a first UE (e.g., UE 432), a MAC-I 806-2 for a second UE (e.g., UE 434), and a MAC-I 806-3 for a third UE (e.g., UE 436). It is readily understood the one or more MAC-I information 806 may include fewer or more MAC-Is as a number of connected UEs changes in other embodiments.

Turing back to FIG. 7, each of the UEs 432, 434, and 436 may be configured to update, at step 720, its own key after receiving the success indication from the IAB node 426. Specifically, each UE may be configured to extract a respective NCC from the success indication received from the IAB node 426. The new NCC may be associated with the target donor CU 410 and may be used to update the UE's key. The UE may then use the updated key for secured communication with the target donor CU 410.

In some embodiments, if the UE-dedicated RRC message is used for the success indication at step 718, each of the UEs 432, 434, and 436 may be configured to transmit, at step 722, an RRC confirmation message to the IAB mode 426. The RRC confirmation may be transmitted in response to the success indication and upon completion of the update of the key of the UE, thereby indicating to the IAB node 426 that the UE has successfully updated its key.

Upon receiving the RRC confirmation message from all the UEs 432, 434, and 436, the IAB node 426 may be configured to transmit, at step 724 and to the target donor CU 410, an indication that the group RRC reestablishment between the UEs and the target donor CU 410 is complete. For example, the IAB node 426 may include a new information element (IE) in the GNB-DU CONFIGURATION UPDATE message, which serves an indication on group RRC reestablishment complete. The GNB-DU CONFIGURATION UPDATE message including the new IE may be transmitted to notify the target donor CU 410 of completion of the group RRC reestablishment.

In some embodiments, if the group common RRC message is used for the success indication at step 718, each of the UEs 432, 434, and 436 may not transmit the RRC confirmation message to the IAB mode 426. Instead, the IAB node 426 may activate a particular timer after sending the success indication at the step 718. If the particular timer expires after a specified duration, the IAB node 426 may assume that the UEs 432, 434, and 436 have all successfully updated its key. In response to expiration of the particular timer, he IAB node 426 may then transmit, at step 724, the indication that the group RRC reestablishment between the UEs and the target donor CU is complete.

FIG. 9 illustrates an exemplary group RRC reestablishment flow 900 when the RRC reestablishment fails, according to embodiments disclosed herein.

In some embodiments, steps 902, 904, 906, 908 and 910 of the group RRC reestablishment flow 900 are generally the same as steps 702, 704, 706, 708 and 710 described above with respect to the group RRC reestablishment flow 700. Therefore, detailed discussion about steps 902, 904, 906, 908 and 910 will be omitted herein.

In some embodiments, if the source donor CU 406 fails to prepare valid UE context as requested by the target donor CU 410, the source donor CU 406 may be configured to transmit a UE context failure response (e.g., a RetrieveUEContextFailure message) at step 912 to the target donor CU 410.

Upon receiving the UE context failure response, or if the target donor CU 410 fails to obtain the requested response for any other reason, the target donor CU 410 will terminate the RRC reestablishment process and initialize an RRC setup process with the IAB node 426 and its connected UEs 432, 434, and 436. A normal RRC setup may be performed. In this case, the target donor CU 410 and the IAB node 426 may communicate an indication on the RRC setup process (for example, an RRCSetup/complete meassage) at step 914.

After step 914, DU configuration associated with the IAB node 426 may be co-located at step 916. The co-location may involve the IAB node 426, the source parent node 414 (not shown) of the IAB node 426, the target parent node 420 (not shown) of the IAB node 426, the source donor CU 406, and the target donor CU 410. Specifically, given that the IAB node 426 has migrated from the source donor CU 406 to the target donor CU 410, DUs associated with the IAB node 426 need to be changed from an old configuration associated with the source donor CU 406 to a new configuration associated with the target donor CU 410. In some embodiments, DUs associated with the IAB node 426 may include each DU that is included in a RAN node proceeding the IAB node 426.

In some embodiments, in response to failure of the group RRC reestablishment (such as receiving the indication in step 914), the IAB node 426 may be configured to transmit a failure indication to the connected UEs 432, 434, and 436 at step 918. Because the target donor CU 410 do not have UE context of the connected UEs 432, 434, and 436, the failure indication may be a second group common indication (instead of a UE-dedicated indication) to all the connected UEs 432, 434, and 436.

In some embodiments, the second group common indication may be carried in a L2 (e.g., MAC CE) signaling. For example, the DU 430 of the IAB node 426 may be configured to send a group common MAC CE signaling to all the connected UEs 432, 434, and 436. The group common MAC CE signaling may be sent via Group Radio Network Temporary Identity (G-RNTI) scheduling. In some embodiments, the G-RNTI for transmission of the group common MAC CE signaling may be preconfigured to the UEs 432, 434, and 436 via a UE-dedicated signaling. In alternative embodiments, the G-RNTI for transmission of the group common MAC CE signaling may be derived based on Cell Radio Network Temporary Identity (C-RNTI) associated with the UEs 432, 434, and 436. It is readily understood that other L2 signaling may be used to carry the second group common indication, not limited to the MAC CE signaling.

In some embodiments, the second group common indication may be carried in a L1 (e.g., DCI) signaling. For example, the DU 430 of the IAB node 426 may be configured to send a group common DCI signaling to all the connected UEs 432, 434, and 436. It is readily understood that other L1 signaling may be used to carry the first group common indication, not limited to the DCI signaling.

In some embodiments, the second group common indication, which indicates failure of the group RRC reestablishment, may send the connected UEs 432, 434, and 436 to an idle state. Upon receiving the second group common indication from the IAB node 426, each of the connected UEs 432, 434, and 436 may be configured to release its connection with the DU 430 of the IAB node 426 and enter the idle state at step 920.

In alternative embodiments, in response to failure of the group RRC reestablishment (such as receiving the indication in step 914), the IAB node 426 may be configured to transmit, to the target donor CU 410, an RRC setup request message on behalf of the connected UEs 432, 434, and 436. This alternative approach may avoid cell search and cell reselection procedure, as compared to transmitting the failure indication at the step 918.

Although the flow 700 and flow 900 are mainly discussed with respect to the example of FIG. 4, these flows may also apply to the example of FIG. 5 in a similar manner except for a few differences.

Given that the mobile IAB node 526 is an intermediate IAB node with one or more descendent IAB node(s), the UE context response sent in step 712 may be slightly different. Specifically, because the IAB node 532 (which is a descendent node of the mobile IAB node 526) and its connected UEs will migrate along with the mobile IAB node 526, the UE context response sent in step 712 may further include an identifier of the DU 536 of the IAB node 532, in addition to the identifier of the DU 530 of the IAB node 526. The UE context response may also include UE context of all the UEs that are connect to the descendent IAB node 532. In this case, the UE context response may include one or more of: (1) identifiers of the DU 530 and the DU 536, (2) UE context of the MT 528, and/or (3) UE context of the MT 534 (which appears as a UE to the IAB node 526) and UE context of each of UEs 538, 540, and 542.

It is readily understood that the example of FIG. 5 is merely an example, the mobile IAB node 526 in other embodiments may include more levels of descendent IAB nodes and each of these descendent IAB nodes may be connected to a respective set of UEs. In such embodiments, the UE context response may preferably include UE context for each UE that is connected to any of the mobile IAB node 526 or the descendent IAB nodes.

In addition, each message/signaling/indication that is communicated between the IAB node 426 and its connected UEs in the example of FIG. 4 may be similarly communicated between the IAB node 526 and the MT 534 of the IAB node 532, because the MT 534 appears like a UE to the IAB node 526. For example, the MT 534 may receive the first group common indication, the success indication, and/or the second group common indication as described above from the IAB node 526. The IAB node 532 in turn communicates these messages/signaling/indications with its connected UEs 538, 540 and 542 in a similar manner, for example, via the group common indication/UE-dedicated indication as described above.

The group RRC reestablishment process described herein provides enhancements related to group mobility of IAB nodes, such as mitigation of interference (including avoidance of potential reference and control signal collisions), reduction of signaling overhead, and/or optimization of performance.

Embodiments contemplated herein include an apparatus comprising means to perform one or more elements of the method 600 or the process 700 or 900 described herein. This apparatus may be, for example, an apparatus of a UE (such as a wireless device 202 that is a UE, as described herein), or an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method 600 or the process 700 or 900. This non-transitory computer-readable media may be, for example, a memory of a UE (such as a memory 206 of a wireless device 202 that is a UE, as described herein), or a memory of a base station (such as a network device 218 that is a base station, as described herein).

Embodiments contemplated herein include an apparatus comprising logic, modules, or circuitry to perform one or more elements of the method 600 or the process 700 or 900. This apparatus may be, for example, an apparatus of a UE (such as a wireless device 202 that is a UE, as described herein) or an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method 600 or the process 700 or 900. This apparatus may be, for example, an apparatus of a UE (such as a wireless device 202 that is a UE, as described herein) or an apparatus of a base station (such as a network device 218 that is a base station, as described herein).

Embodiments contemplated herein include a signal as described in or related to one or more elements of the method 600 or the process 700 or 900.

Embodiments contemplated herein include a computer program or computer program product comprising instructions, wherein execution of the program by a processor is to cause the processor to carry out one or more elements of the method 600 or the process 700 or 900. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein) or a memory of a base station (such as a network device 218 that is a base station, as described herein).

At least the following embodiments are disclosed herein:
1. A computing apparatus for use with an Integrated Access and Backhaul (IAB) node, the computing apparatus comprising:
a processor; and
a memory storing instructions that, when executed by the processor, configure the IAB node to:
   in response to a trigger event associated with a group radio resource control (RRC) reestablishment with a target donor center unit (CU), transmit a first group common indication to all of a plurality of user equipment (UEs) that are connected to the IAB node; and
   in response to success of the group RRC reestablishment, transmit a success indication to the plurality of UEs.
2. The computing apparatus of claim 1, wherein the IAB node is a mobile IAB node.
3. The computing apparatus of claim 1, wherein the trigger event comprises at least one of:
a radio link failure associated with the IAB node or one of its parent IAB nodes; or
a handover failure associated with the IAB node.
4. The computing apparatus of claim 1, wherein first group common indication indicates the plurality of UEs to stop a data inactivity timer and/or suspend data transmission and/or reception.
5. The computing apparatus of claim 1, wherein the first group common indication comprises a group common MAC CE signaling to all the plurality of UEs.
6. The computing apparatus of claim 5, wherein the IAB node is configured to transmit the first group common indication at least by:
transmitting the group common MAC-CE signaling, by a Distributed Unit (DU) of the IAB node and via Group Radio Network Temporary Identity (G-RNTI) scheduling, to all the plurality of UEs,
wherein the G-RNTI for transmission of the group common MAC CE signaling is preconfigured to the UEs via a UE-dedicated signaling or derived based on Cell Radio Network Temporary Identity (C-RNTI) associated with the UEs.
7. The computing apparatus of claim 1, wherein the first group common indication comprises a group common downlink control information (DCI) signaling to all the plurality of UEs.
8. The computing apparatus of claim 1, wherein the group RRC reestablishment with the target donor CU is based on at least UE context that is retrieved by the target donor CU from a source donor CU associated with the IAB node.
9. The computing apparatus of claim 8, wherein the UE context information comprises one or more of:
identifiers of one or more distributed units (DUs) associated with the IAB node;
UE context of one or more mobile terminations (MTs) associated with the IAB node; or
UE context of all the plurality of UEs that are connected to the IAB node.
10. The computing apparatus of claim 1, wherein transmitting the success indication comprises:
transmitting a UE-dedicated RRC message to each UE of the plurality of UEs, wherein the UE-dedicated RRC message includes a respective NextHop Chaining Counter (NCC) for said each UE to update a respective key of that UE.
11. The computing apparatus of claim 10, wherein the UE-dedicated RRC message is included in a Signal Radio Bearer 1 (SRB1) message with only integrity protection but no ciphering.
12. The computing apparatus of claim 1, wherein transmitting the success indication comprises:
transmitting a group common RRC message to all the plurality of the UEs, wherein the UE group common RRC message includes a list of NextHop Chaining Counters (NCCs), each of which is used for a respective UE of the plurality of UEs.
13. The computing apparatus of claim 12, wherein, for each UE of the plurality of UEs, the group common MAC-CE RRC message further includes a Message Authentication Code-Integrity (MAC-I) that is specific to said each UE.
14. The computing apparatus of claim 12, wherein the IAB node is configured to transmit the success indication at least by:
transmitting the group common MAC-CE signaling, by a Distributed Unit (DU) of the IAB node and via Group Radio Network Temporary Identity (G-RNTI) scheduling, to all the plurality of UEs,
wherein the G-RNTI for transmission of the group common MAC CE signaling is preconfigured to the UEs via a UE-dedicated signaling or derived based on Cell Radio Network Temporary Identity (C-RNTI) associated with the UEs.
15. The computing apparatus of claim 12, wherein the instructions, when executed by the processor, configure the IAB node to further:
transmit, to the target donor CU, an indication that the group RRC reestablishment is complete.
16. The computing apparatus of claim 1, wherein the instructions, when executed by the processor, configure the IAB node to further:
receive, from the plurality of the UEs, an RRC confirmation message that is responsive to the success indication.
17. The computing apparatus of claim 1, wherein the instructions, when executed by the processor, configure the IAB node to further:
in response to failure of the RRC reestablishment, transmit a second group common indication to all the plurality of UEs.
18. The computing apparatus of claim 17, wherein the second group common indication sends the plurality of UEs to an idle state.
19. The computing apparatus of claim 17, wherein the second group common indication includes at least one of:
a group common MAC CE signaling; or
a group common DCI signaling.
20. The computing apparatus of claim 1, wherein the instructions, when executed by the processor, configure the IAB node to further:
in response to failure of the RRC reestablishment, transmit, to the target donor CU, an RRC setup request message on behalf of the plurality of UEs.
21. A method performed by an Integrated Access and Backhaul (IAB) node, the method comprising:
in response to a trigger event associated with a group radio resource control (RRC) reestablishment with a target donor center unit (CU), transmitting a first group common indication to all of a plurality of user equipment (UEs) that are connected to the IAB node; and
in response to success of the group RRC reestablishment, transmitting a success indication to the plurality of UEs.
22. A computing apparatus for use with a user equipment (UE), the computing apparatus comprising:
a processor; and
a memory storing instructions that, when executed by the processor, configure the UE to:
   receive a first group common indication from an Integrated Access and Backhaul (IAB) node to which the UE is connected, the first group common indication indicating a group radio resource control (RRC) reestablishment with a target donor center unit (CU);
   in response to receiving the first group common indication, perform one or more particular actions; and
   in response to receiving, from the IAB node, a success indication associated with success of the group RRC reestablishment, update a key of the UE based on the success indication; and
   in response to receiving, from the IAB node, a second group common indication associated with failure of the group RRC reestablishment, release a connection with the IAB node.
23. A method performed by a user equipment (UE), the method comprising:
receiving a first group common indication from an Integrated Access and Backhaul (IAB) node to which the UE is connected, the first group common indication indicating a group radio resource control (RRC) reestablishment with a target donor center unit (CU);
in response to receiving the first group common indication, performing one or more particular actions; and
in response to receiving, from the IAB node, a success indication associated with success of the group RRC reestablishment, updating a key of the UE based on the success indication; and
in response to receiving, from the IAB node, a second group common indication associated with failure of the group RRC reestablishment, releasing a connection with the IAB node.
24. A computing apparatus for use with a donor centralized unit (CU), the computing apparatus comprising:
a processor; and
a memory storing instructions that, when executed by the processor, configure the donor CU to:
   receive, from an IAB node, an RRC reestablishment request;
   in response to receiving the RRC reestablishment request, transmit a UE context request to a source donor CU to which the IAB node was previously connected to;
   receive a UE context response from the source donor CU, wherein the UE context response includes UE context for a plurality of UEs that are connected to the IAB node; and
   perform a group RRC reestablishment with the plurality of UEs based on the UE context response.
25. A method performed by a donor centralized unit (CU), the method comprising:
receiving, from an IAB node, an RRC reestablishment request;
in response to receiving the RRC reestablishment request, transmitting a UE context request to a source donor CU to which the IAB node was previously connected to;
receiving a UE context response from the source donor CU, wherein the UE context response includes UE context for a plurality of UEs that are connected to the IAB node; and
performing a group RRC reestablishment with the plurality of UEs based on the UE context response.
26. A computing apparatus for use with a donor centralized unit (CU), the computing apparatus comprising:
a processor; and
a memory storing instructions that, when executed by the processor, configure the donor CU to:
   receive a UE context request from a target donor CU to which an IAB node is migrating; and
   transmit a UE context response to the target donor CU, wherein the UE context response includes UE context for a plurality UEs that are connected to the IAB node.
27. A method performed by a donor centralized unit (CU), the method comprising:
receiving a UE context request from a target donor CU to which an IAB node is migrating; and
transmitting a UE context response to the target donor CU, wherein the UE context response includes UE context for a plurality UEs that are connected to the IAB node.
28. A non-transitory computer readable medium comprising instructions that, when executed by one or more processors, cause the one or more processors to perform the method of any of embodiments above.
29. A computer program product comprising computer programs that, when executed by one or more processors, cause the one or more processors to perform the method of any of embodiments above.
30. An apparatus comprising means for performing the method of any of embodiments above.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A computing apparatus for use with an Integrated Access and Backhaul (IAB) node, the computing apparatus comprising:
a processor; and
a memory storing instructions that, when executed by the processor, configure the IAB node to:
in response to a trigger event associated with a group radio resource control (RRC) reestablishment with a target donor center unit (CU), transmit a first group common indication to all of a plurality of user equipment (UEs) that are connected to the IAB node; and
in response to success of the group RRC reestablishment, transmit a success indication to the plurality of UEs.

2. The computing apparatus of claim 1, wherein the IAB node is a mobile IAB node.

3. The computing apparatus of claim 1, wherein the trigger event comprises at least one of:
a radio link failure associated with the IAB node or one of its parent IAB nodes; or
a handover failure associated with the IAB node.

4. The computing apparatus of claim 1, wherein first group common indication indicates the plurality of UEs to stop a data inactivity timer and/or suspend data transmission and/or reception.

5. The computing apparatus of claim 1, wherein the first group common indication comprises a group common MAC CE signaling to all the plurality of UEs.

6. The computing apparatus of claim 5, wherein the IAB node is configured to transmit the first group common indication at least by:
transmitting the group common MAC-CE signaling, by a Distributed Unit (DU) of the IAB node and via Group Radio Network Temporary Identity (G-RNTI) scheduling, to all the plurality of UEs,
wherein the G-RNTI for transmission of the group common MAC CE signaling is preconfigured to the UEs via a UE-dedicated signaling or derived based on Cell Radio Network Temporary Identity (C-RNTI) associated with the UEs.

7. The computing apparatus of claim 1, wherein the first group common indication comprises a group common downlink control information (DCI) signaling to all the plurality of UEs.

8. The computing apparatus of claim 1, wherein the group RRC reestablishment with the target donor CU is based on at least UE context that is retrieved by the target donor CU from a source donor CU associated with the IAB node.

9. The computing apparatus of claim 8, wherein the UE context information comprises one or more of:
identifiers of one or more distributed units (DUs) associated with the IAB node;
UE context of one or more mobile terminations (MTs) associated with the IAB node; or
UE context of all the plurality of UEs that are connected to the IAB node.

10. The computing apparatus of claim 1, wherein transmitting the success indication comprises:
transmitting a UE-dedicated RRC message to each UE of the plurality of UEs, wherein the UE-dedicated RRC message includes a respective NextHop Chaining Counter (NCC) for said each UE to update a respective key of that UE.

11. The computing apparatus of claim 10, wherein the UE-dedicated RRC message is included in a Signal Radio Bearer 1 (SRB1) message with only integrity protection but no ciphering.

12. The computing apparatus of claim 1, wherein transmitting the success indication comprises:
transmitting a group common RRC message to all the plurality of the UEs, wherein the UE group common RRC message includes a list of NextHop Chaining Counters (NCCs), each of which is used for a respective UE of the plurality of UEs.

13. The computing apparatus of claim 12, wherein, for each UE of the plurality of UEs, the group common MAC-CE RRC message further includes a Message Authentication Code—Integrity (MAC-I) that is specific to said each UE.

14. The computing apparatus of claim 12, wherein the IAB node is configured to transmit the success indication at least by:
transmitting the group common MAC-CE signaling, by a Distributed Unit (DU) of the IAB node and via Group Radio Network Temporary Identity (G-RNTI) scheduling, to all the plurality of UEs,
wherein the G-RNTI for transmission of the group common MAC CE signaling is preconfigured to the UEs via a UE-dedicated signaling or derived based on Cell Radio Network Temporary Identity (C-RNTI) associated with the UEs.

15. The computing apparatus of claim 12, wherein the instructions, when executed by the processor, configure the IAB node to further:
transmit, to the target donor CU, an indication that the group RRC reestablishment is complete.

16. The computing apparatus of claim 1, wherein the instructions, when executed by the processor, configure the IAB node to further:
receive, from the plurality of the UEs, an RRC confirmation message that is responsive to the success indication.

17. The computing apparatus of claim 1, wherein the instructions, when executed by the processor, configure the IAB node to further:
in response to failure of the RRC reestablishment, transmit a second group common indication to all the plurality of UEs.

18. The computing apparatus of claim 17, wherein the second group common indication sends the plurality of UEs to an idle state.

19. The computing apparatus of claim 17, wherein the second group common indication includes at least one of:
a group common MAC CE signaling; or
a group common DCI signaling.

20. The computing apparatus of claim 1, wherein the instructions, when executed by the processor, configure the IAB node to further:
in response to failure of the RRC reestablishment, transmit, to the target donor CU, an RRC setup request message on behalf of the plurality of UEs.

21. (canceled)
